(19) United States
(12) Patent Application Publication
(10) Pub. No.: US 2003/0040823 A1
(43) Pub. Date: Feb. 27, 2003

(54) Method and apparatus for multi-design benchmarking

(76) Inventors: Christian Harm, Wien (AT); Guenter Fuhry, Perchtoldsdorf (AT); Nicolas Reinecke, Kranenburg (DE); Philipp Radtke, Munich (DE); Andreas Tschiesner, Munich (DE)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 10/187,449

(22) Filed: Jul. 2, 2002

Related U.S. Application Data
(60) Provisional application No. 60/302,382, filed on Jul. 3, 2001.

(51) Int. Cl. G06F 17/60

(52) U.S. Cl. 700/97; 705/7

(57) ABSTRACT

Embodiments of the present invention are directed to optimizing measure values associated with components of a product, where the measure values relate to quantities of interest, such as, for example, the price of the components, the amount of time that it takes to supply the components, a performance adequacy rating associated with the components, or a safety rating associated with the components. Where the product may be supplied in accordance with more than one design, components from different designs may be selected to further optimize measure values associated with components of the product.

### RELATED APPLICATION

The present application claims the benefit of U.S. provisional patent application serial No. 60/302,382, filed on Jul. 3, 2001 and entitled “Multi-Design Benchmarking,” the entirety of which is herein incorporated by reference.

### FIELD OF THE INVENTION

The present invention relates to optimizing or improving measure values associated with components of a product, and in embodiments more particularly relates to optimizing the manufacturing cost of a product having a number of components that may be outsourced to suppliers.

### BACKGROUND OF THE INVENTION

Minimizing and controlling production costs is critical for business ventures. A common method of controlling such costs is to shift the risk of cost overruns on a non-affiliated party by outsourcing the production process. Additionally, in cases where two or more producers are capable of manufacturing a product or component, the business venture may further reduce costs by picking the supplier that can supply the component or product at the lowest cost. Thus, outsourcing production is often an excellent way of containing manufacturing costs. Outsourcing may be used to optimize the production process in other ways, such as reducing production time or assuring performance or safety of a product or component.

The development of the Internet and other networked environments and their increased use to conduct business to business transactions has provided further assistance to business ventures in minimizing their costs in outsourcing the manufacturing process for a product or component. A business venture may cheaply and easily obtain information on potential suppliers from the Internet or through a wide area network. Moreover, the business venture may more easily communicate with, and provide and obtain information from suppliers through the Internet, wide area network or other communication network.

However, the full potential of outsourcing using electronic media like the Internet as well as in more traditional business practices is yet to be realized. There is a need for a way of further minimizing the costs or otherwise optimizing manufacturing a product, especially where the product includes a number of separate components that may be manufactured or supplied by a number of suppliers.

### SUMMARY OF THE INVENTION

Embodiments of the present invention are directed to optimizing or improving measure values associated with components of a product, where the measure values relate to quantities of interest, such as, for example, the price of the components, the amount of time that it takes to supply the components, a performance adequacy rating associated with the components, or a safety rating associated with the components. In cases where it may be possible to supply the product in accordance with more than one design, components from different designs may be selected to further optimize or improve measure values associated with components of the product.

In one aspect of the invention, a method for making a sourcing decision is provided that comprises the steps of designating a product having a plurality of designs and a set of components; for each component, and for each design incorporating that component, receiving a measure value corresponding to that component incorporated in that design, from each of a plurality of suppliers of that component for that design; and responsive to the received measure values, determining for each component a preferred design and a preferred supplier.

In another aspect of the invention, a method for making a sourcing decision is provided that comprises the steps of designating a product having a plurality of designs and a set of components; for each component, for each design incorporating that component, receiving a measure value corresponding to that component incorporated in that design, from each of a plurality of suppliers of that component for that design; adjusting at least one of the received measure values; and responsive to the previous step, determining a preferred design and a preferred supplier for each component.

In another aspect of the invention, a method for making a sourcing decision is provided that comprises the steps of designating a product having a set of components; for each component, receiving a measure value corresponding to that component, from each of a plurality of suppliers of that component; responsive to the received measure values, determining a preferred supplier for each component; transmitting information on the preferred supplier for each component; and receiving at least one subsequent measure value from at least one of the plurality of suppliers.

In another aspect of the invention, an apparatus for making a sourcing decision is provided that comprises an apparatus for making a sourcing decision, the apparatus comprising (a) a product designation unit connected to a processing unit and configured to designate a product, a plurality of designs for the product and a set of components for the product; (b) an input unit connected to the processing unit and configured to receive: for each component, for each design incorporating that component, a measure value corresponding to that component incorporated in that design, from each of a plurality of suppliers of that component for that design, wherein the processing unit is configured to determine a preferred design and a preferred supplier for each component based on the measure values received by the input unit; and (c) an output unit connected to the processor and configured to transmit information on the preferred design and the preferred supplier for each component.

In another aspect of the invention, an apparatus for making a sourcing decision is provided that comprises (a) a product designation unit connected to a processing unit and configured to designate a product and a set of components for the product; (b) an input unit connected to the processing unit and configured to receive: for each component, a measure value corresponding to that component, from each of a plurality of suppliers of that component, wherein the processing unit is configured to determine a preferred supplier for each component based on the measure values received by the input unit; and (c) an output unit connected to the processor and configured to transmit information on the preferred supplier for each component.

Other aspects of the invention are disclosed and discussed in the following written description, drawings and claims.

### BRIEF DESCRIPTION OF THE DRAWINGS

FIG. 1 is a block diagram of an embodiment of a system in accordance with the present invention.

FIG. 2 shows a flow diagram of an embodiment of a method in accordance with the present invention.

FIG. 3 shows an example of an implementation of a step in the embodiment depicted in FIG. 2.

FIG. 4 shows an example of an implementation of another step in the embodiment depicted in FIG. 2.

FIG. 5 shows one example of a data structure that may be used in embodiments of the present invention.

FIG. 6 shows an example graphical user interface (“GUI”) display displaying product information in a way that may be used in embodiments of the present invention.

FIG. 7 shows an example GUI display displaying product and supplier information in a way that may be used in embodiments of the present invention.

FIG. 8 shows an example GUI display displaying product information and indicating data fields to be completed by a supplier in a way that may be used in embodiments of the present invention.

FIG. 9 shows an example GUI display displaying product information and including data provided by a supplier in a way that may be used in embodiments of the present invention.

FIG. 10 shows an example GUI display displaying costs of a product and its components under different designs according to a particular supplier, in a way that may be used in embodiments of the present invention.

FIG. 11 shows an example GUI display displaying costs of the product and its components under a single design according to different suppliers, in a way that may be used in embodiments of the present invention.

FIG. 12 shows an example GUI display displaying product and component information and indicating benchmark supplier information, in a way that may be used in embodiments of the present invention.

FIG. 13 shows an example GUI display displaying product and component information, indicating benchmark supplier information for different product designs, and indicating benchmark design information, in a way that may be used in embodiments of the present invention.

FIG. 14 shows a GUI display displaying example feedback information that may be provided to one or more suppliers, in a way that may be used in embodiments of the present invention.

FIG. 15 shows a computer-implemented apparatus embodiment of the present invention and an embodiment incorporating a computer-readable medium.

### DETAILED DESCRIPTION OF THE INVENTION

Embodiments of the invention allow the minimization of the manufacturing or supply costs of a product, where the product has a number of components which may be separately supplied by one or more supplier. More generally, embodiments of the invention allow optimizing or improving measure values associated with components of a product, where the measure values relate to physical or other quantities of interest, such as price, production time, or product or component performance. In cases where it may be possible to supply the product in accordance with more than one design, components from different designs may be selected to further minimize the costs of the product or optimize other measure values. Additionally, information on the possibility of achieving lower costs or optimizing other measure values may be communicated to one or more suppliers with the goal of receiving subsequent bids from these suppliers to further reduce costs or further optimize designated measure values.

Methods and apparatus in accordance with the invention may be implemented at a node in a network like the Internet allowing a remote user to, for example, utilize cost minimization services provided at or through the node to determine the lowest cost manufacturers of components of a product. The suppliers may also be connected to such a network so that the services offered by the node may be provided to the user in a seamless manner over the network. Once bids are received on components of the products from the suppliers under, for example, a specific design, the lowest cost set of components and associated suppliers may be determined as a benchmark for evaluating the bids of the suppliers. Additionally, where more than one design of the product is under consideration a benchmark may be determined by additionally considering all of the different designs and selecting the supplier and the design yielding the lowest cost for each component of the product. Information on benchmarks may be communicated to the suppliers to solicit lower bids with a view to further minimizing the cost of the product.

More broadly, one may use embodiments of the invention to solicit measure values from suppliers for the components of a product under one or more designs, and determine benchmarks for optimizing parameters that are a function of the received measure values (e.g., such as total cost of ownership of the product, including taxes, transportation and other costs, where the measure values reflect the costs of the components; or alternatively, the total production time where the measure values reflect the time required to manufacture the components and assemble them). Under such a general formulation, the costs of components of a product are but one specific example of a measure value. The benchmark information may be transmitted to the suppliers in order to receive revised (i.e., subsequent) measure values that are “more optimal”, i.e., better than or improved compared to those received earlier.

In specific embodiments, the measure values received from suppliers of a product represent the cost estimates for supplying these components, that is, bids by suppliers on the cost of supply of these components to the user. In such embodiments, optimization based on the aggregate cost of the product, or based on a specified function of the costs of one or more components are examples of the many different types of optimization that maybe performed. For example, a user may want to optimize or improve her costs for obtaining a car mirror assembly, where the car mirror assembly has a mirror component, a housing component and an attachment component for attaching the mirror. Moreover, the car mirror assembly may be manufactured under a number of different designs—e.g., design A and design B (in this example, each design of the product incorporates the same three components, although embodiments of the invention encompass products having different designs incorporating different sets of components.) The user may obtain bids from a number of suppliers who may supply one or more components of the product, under the designs being considered. Thus, the user may obtain, from each of the possible suppliers, cost estimates for supplying each of the three components under each of design A and design B of the car mirror assembly. The user may evaluate a benchmark for each design by determining, for each component, the lowest bid received for that component under the considered design. Further, the user may additionally determine a benchmark for the product by determining, for each component, the lowest bid received for that component taking account of the bids from each of the suppliers for that component under each of the designs being considered. The user may utilize these benchmarks, for example, to bargain for even lower costs from the suppliers. In addition to this, or alternatively, the user may also use such benchmark information for making sourcing decisions in determining the best design for each component and the associated supplier.

For purposes of illustration, a cost minimization system is considered in order to exemplify the principles in embodiments of the invention. It will be apparent to one skilled in the art in view of the specification how to implement and use the present invention with other measure values.

A user of a cost minimization system in accordance with an embodiment of the present invention may communicate information identifying a desired product to the cost minimization system. Such information may include information allowing the cost minimization system to determine the identity of the components of the product as well as suppliers supplying the product and/or specific components of the product. The cost minimization system may then contact the identified suppliers and obtain bids on the costs of components supplied by the respective suppliers. The cost minimization system may then determine, for each component of the product, the lowest bid made for that component and the associated supplier making the lowest bid. The aggregation of this information is defined to be the “benchmark supplier.” “Benchmark supplier information” is defined as any subset (including the benchmark supplier as the maximal subset) of this aggregation of information, any information derivable from the benchmark supplier, or a combination thereof. Thus, the benchmark supplier information may indicate to the user that the cost of the product may be minimized or reduced by obtaining different components of the product from different suppliers. The cost minimization system may transmit benchmark supplier information to one or more of the suppliers with a view to receiving revised (i.e., subsequent) bids from the suppliers that are lower than the bids received from the suppliers earlier. In this way, the user may leverage the benchmark supplier information to obtain lower bids from the suppliers.

In certain cases, a product may be manufactured in accordance with a number of designs, which may include distinctive designs for the product. A supplier of a component of the product may specify different prices for that component under different designs of the product. In that case, the cost minimization system may determine, for each component of the product, the lowest bid for that component considering the costs of that component under each design, according to bids received from all suppliers. This information, together with the supplier submitting the lowest bid and the corresponding design for each component of the product, constitute the “benchmark design” for the product (i.e., for each component, the lowest bid, and the manufacturer and the design corresponding to the lowest bid). The “benchmark design information” is defined as any subset (including the benchmark design as the maximal subset) of the benchmark design, any information derivable from the benchmark design, or a combination thereof. The cost minimization system may transmit benchmark design information to one or more of the suppliers with a view to receiving revised (i.e., subsequent) bids from the suppliers that are lower than the earlier bids received from the suppliers. In this way, the user may leverage the benchmark design information to obtain lower bids from the suppliers.

For other embodiments, benchmark design information and benchmark supplier information may represent benchmarks based on measure values other than price. For example, measure values, representing an attribute other than price (e.g., including but not limited to supply time, a performance adequacy rating, a safety rating), or a combination of attributes, may be obtained from suppliers and used according to the present invention. In such cases the benchmark supplier and benchmark design may be based on the measure values received from suppliers, in a way apparent to those of skill in the art in view of the specification.

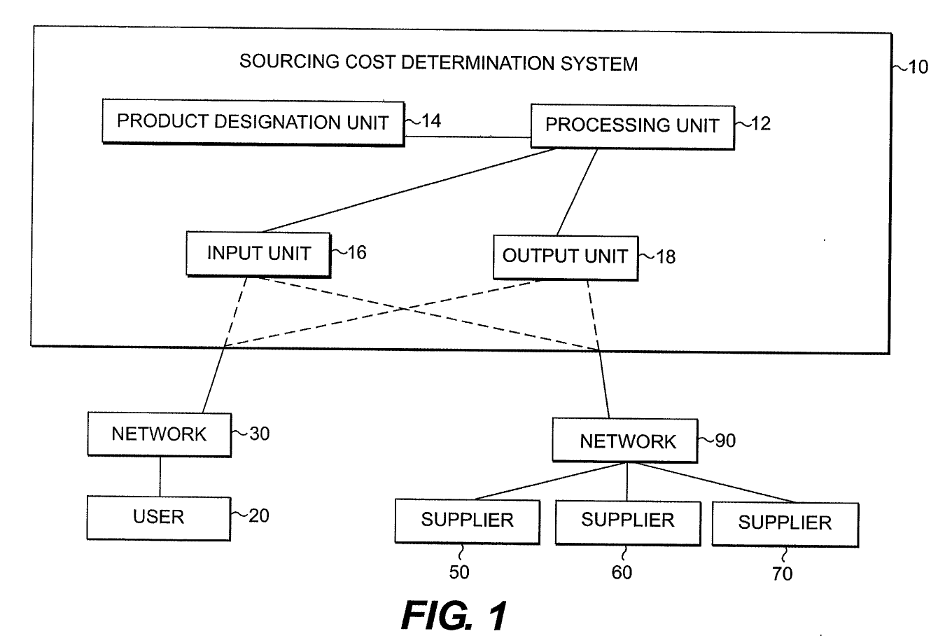

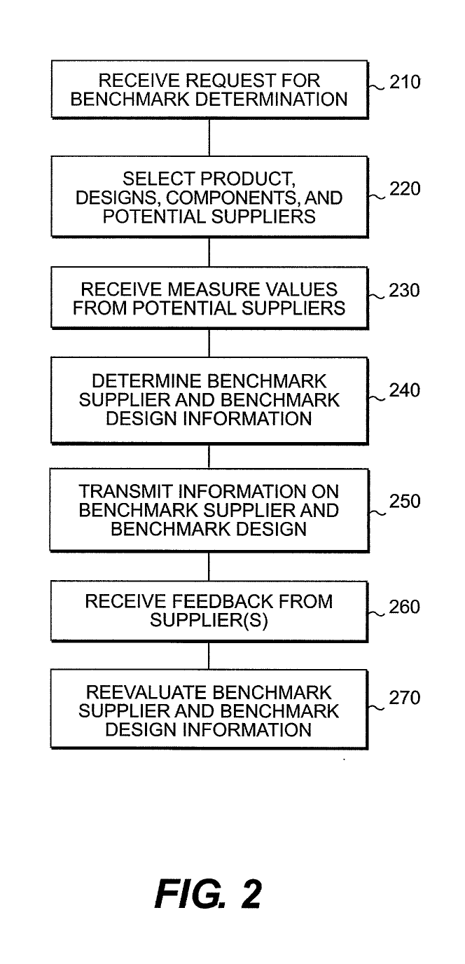

FIG. 1 illustrates a system suitable for use with embodiments incorporating a cost minimization system according to the present invention. The system shown in FIG. 1 may be used to execute a method embodiment of the invention as discussed later and, for example, illustrated in FIG. 2. In FIG. 1, Sourcing Cost Determination System 10 is connected through Network 30 to User 20. Sourcing Cost Determination System 10 is also connected through Network 90 to Supplier 70, Supplier 60 and Supplier 50. Although three suppliers have been shown in FIG. 1, it is to be understood that any number of suppliers may be connected to sourcing Cost Determination System 10 through a network like Network 90. Sourcing Cost Determination System 10 may offer cost minimization or other optimization services to User 20 who may be seeking the optimal supplier for a product.

In the embodiment depicted in FIG. 1, Network 30 may be any communications network, including but not limited to the Internet, a local area network, a land-based telephone network or a wireless telephone network, or any combination thereof. Network 90 may also be any one or any combination of these networks. In some embodiments, Network 90 and Network 30 may be distinct networks, whereas in other embodiments they may be identical or overlapping networks.

As depicted in FIG. 1, Sourcing Cost Determination System 10 of FIG. 1 contains a Processing Unit 12 that is connected to Product Designation Unit 14, Input Unit 16 and Output Unit 18. Input Unit 16 and Output Unit 18 may include, for example, a keyboard, a display and/or a connection to a network or other device. In the embodiment shown at FIG. 1, User 20 connects to Sourcing Cost Determination System 10 through Network 30 in order to determine the optimum sourcing cost for a product from among a number of suppliers, for example Suppliers 50, 60 and 70, who are connected through Network 90 to the Sourcing Cost Determination System 10.

FIG. 2 shows a flow chart illustrating the steps in an embodiment of the present invention. In step 210, a request is received for a benchmark determination. For example, the Sourcing Cost Determination System 10 of FIG. 1 may receive a request for a benchmark cost determination from User 20 through Network 30. In step 220, a product and associated designs, components and potential suppliers (i.e., bidders) are selected. For example, Product Designation Unit 14 of Sourcing Cost Determination System 10 may select a product and its associated designs, components and potential suppliers after receiving a communication from User 20 through Network 30 that specifies, indicates or otherwise identifies this information.

In step 230, measure values are received from potential suppliers. Such measure values, for example, may include information on the prices of various components of the product under various designs of the product. More generally, a measure value is a quantity associated with a product or a component of a product that may be received by the user or the service provider providing services to the user. Examples of measure values include, but are not limited to, supply or production time of the components, performance adequacy ratings, and safety or other ratings. Further, measure values may also include qualitative information such as a non-numeric indication of quality, a credit rating or other non-numeric indications of a quality associated with the product, component, design or supplier that may be translated into a quantitative measure value or that may be used to modify quantitative measure values.

For purposes of illustration only, one may consider measure values representing pricing information of the components of the products. In such an illustration, each of Suppliers 50, 60 and 70 may transmit such pricing information to Sourcing Cost Determination System 10 after a request for such information has been transmitted by Sourcing Cost Determination System 10 to each of these suppliers.

In step 240, benchmark supplier information and benchmark design information are determined from the information received from the suppliers in step 230. For example, Processing Unit 12 may process all the measure values received from the suppliers in step 230 to determine benchmark supplier information and benchmark design information for the product. Such information reflects the preferred supplier and/or the preferred design for each component of the product. The preferred supplier and preferred design for each component correspond to the optimized measure value considered for that component.

Optionally, as either part of step 240 or step 250, information on the benchmark supplier and/or benchmark design may be displayed or made available to the user. Further, Sourcing Cost Determination System 10 may receive preferences from the user regarding what subset of the benchmark supplier and/or benchmark design information is to be transmitted to the user. Sourcing Cost Determination System 10 may then only transmit information in a manner consistent with the received preferences to the suppliers in step 250. The optional provision of preference information by the user and its reception by Sourcing Cost Determination System 10 may provide flexibility to the user in tailoring the capabilities of Sourcing Cost Determination System 10 for the benefit of the user.

In step 250 benchmark supplier and benchmark design information determined in step 240 is transmitted. For example, this information may be transmitted by Processing Unit 12 through Output Unit 18 to User 20. Moreover, such information may be transmitted to one or more of the suppliers who had provided measure values in step 230.

In the embodiment illustrated in FIG. 2, feedback is received in step 260 from each of the suppliers. For example, Sourcing Cost Determination system 10 may receive such feedback through Input Unit 16 from each or a sub-set of suppliers who had provided measure values in step 230. Such feedback information may include revised measure values (such as revised or subsequent pricing information in the form of revised bids) received from the suppliers in response to the transmission of benchmark supplier and benchmark design information to them in step 250.

In step 270 subsequent benchmark supplier and benchmark design information are determined (for example, benchmark supplier and benchmark design information determined in step 240 is changed or otherwise updated). For example, subsequent benchmark supplier and benchmark design information may be evaluated based on the feedback information received from the suppliers in step 260. Such subsequent benchmark supplier and benchmark design information contain information on the updated preferred supplier and/or preferred design for each component of the product. The updated preferred supplier and/or preferred design for each component correspond to the most optimal measure value considered for that component.

Steps 260 and 270 are optional steps that may not be present in some embodiments of the present invention. For example, in some embodiments, sourcing decisions may be made on the basis of benchmark information determined in step 240.

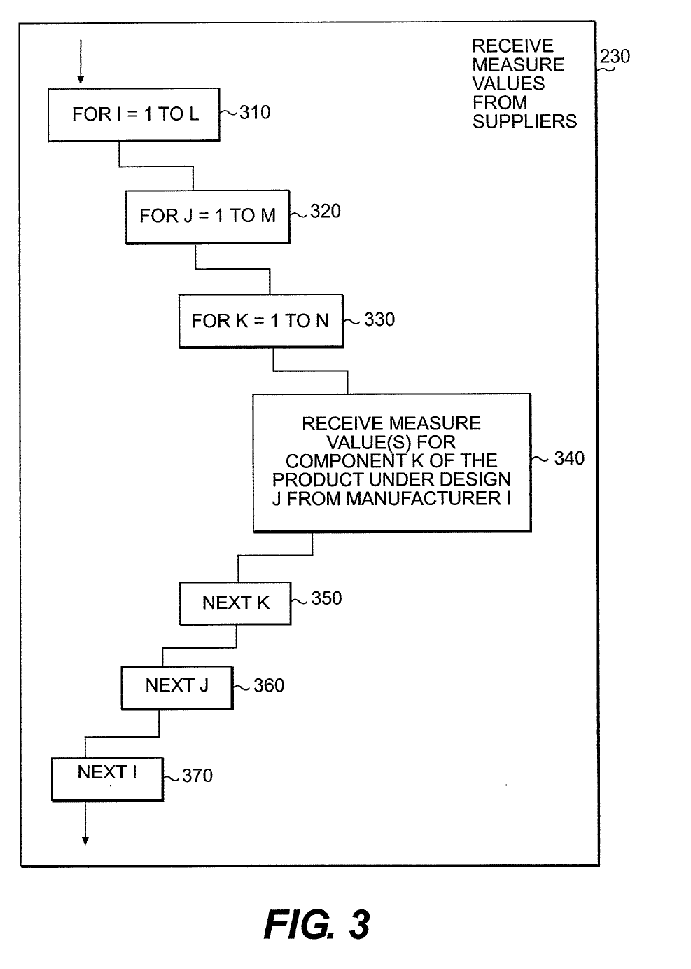

FIG. 3 illustrates the sub-steps that may be included in an exemplary implementation of step 230 of FIG. 2, in which measure values are received from suppliers. The sub-steps shown in FIG. 3 are for purposes of illustration only and one skilled in the art will, in view of this specification, readily recognize other algorithms that will serve the same or substantially similar functions. In sub-step 310, an execution loop is initiated in which a variable ranges over the identification tags of each of the suppliers from whom measure values are to be received. In step 320, an execution loop is initiated in which a variable ranges over the identification tags of each of the designs to be considered for this product. In step 330, an execution loop is initiated in which a variable ranges over the identification tags of each of the components of the product incorporated by the currently identified design. In step 340, a pricing measure value is received for the currently identified component of the product under the currently identified design from the currently identified supplier. In sub-step 350, control is returned to the execution loop of step 330, and the identification tag variable ranging over components of the product is incremented. In sub-step 360, control is returned to the execution loop of step 320, and the identification tag variable ranging over designs of the product is incremented. In sub-step 370, control is returned to the execution loop of step 310, and the identification tag variable ranging over suppliers is incremented.

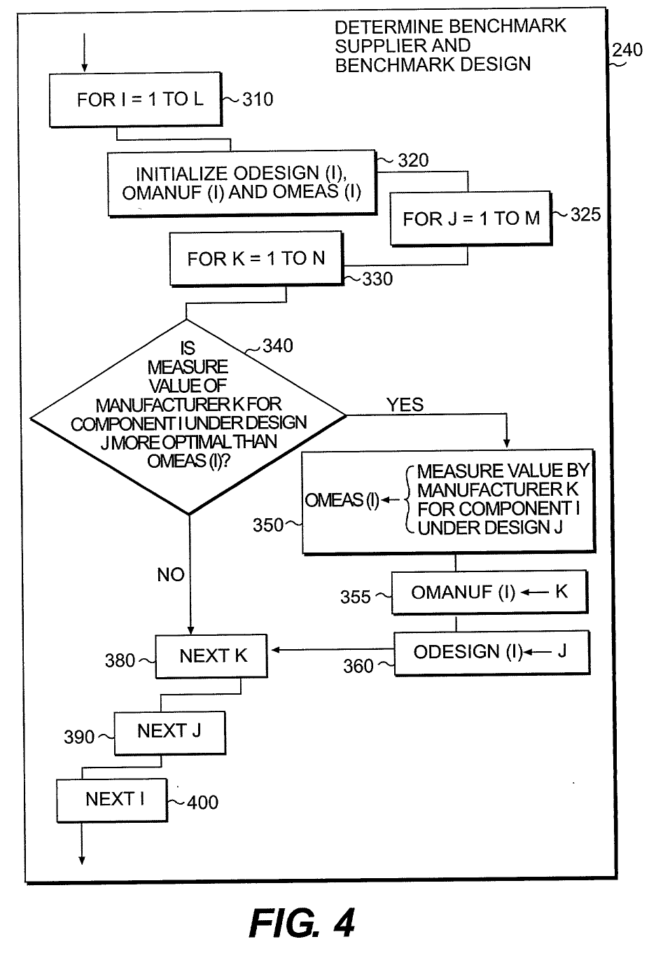

FIG. 4 illustrates the sub-steps that may be included in an exemplary implementation of step 240 of FIG. 2 in which benchmark supplier and benchmark design information are determined. The sub-steps shown in FIG. 4 are for purposes of illustration only and one skilled in the art will, in view of the present specification, readily recognize other algorithms that will serve the same or substantially similar functions. In sub-step 310 an execution loop is initiated in which the variable I ranges over the identification tags of the components of the selected product.

In sub-step 320, arrays that will be used to determine benchmark design and benchmark supplier information are initialized. In the implementation depicted in FIG. 3, the I^{th} element of each of the arrays ODESIGN, OMANUF and OMEAS is determined. The I^{th} element of array OMEAS will ultimately indicate the optimal measure value for the I^{th} component of the selected product. The I^{th} element of array ODESIGN will ultimately indicate the design corresponding to the optimal measure value for the I^{th} component of the product. Similarly, the I^{th} element of array OMANUF will ultimately indicate the supplier corresponding to the optimal measure value for the I^{th} component of the selected product.

In a context where the goal is the minimization of the measure values for components, the values for the entries of array OMEAS may be initialized to a large number, e.g., a number that exceeds the expected maximum measure value from among all the measure values received. Similarly, the values for the entries of arrays ODESIGN and OMANUF may be initialized to values not indexing a design under consideration and a supplier under consideration, respectively (e.g., they may be initialized by a negative number, assuming that number does not designate a supplier or design that is being considered.) Other adequate methods for initialization in this context as well as appropriate methods for initialization in other contexts will be readily apparent to one skilled in the art in view of this specification.

Continuing with the same example, in sub-step 325, an execution loop is initiated in which a variable ranges over the identification tags of each of the designs under consideration for the selected product. In sub-step 330, an execution loop is initiated in which a variable ranges over the identification tags of each of the potential suppliers of the component under consideration for the design under consideration of the selected product.

In decision sub-step 340, a determination is made as to whether the measure value from the currently identified supplier for the currently identified component under the currently identified design is “more optimal” than the value for the I^{th} component of array OMEAS. Where the measure values represent price and the goal of the user is to minimize the price of supply of the production components of the product, “more optimal” may mean that the price is lower. (More generally, optimality may be defined by the user or the user's service provider in terms of a function of the defined measure values representing attributes of interest to the user.)

If the measure value is “more optimal” than the I^{th} element of array OMEAS (or otherwise represents an improvement over the I^{th} element of array OMEAS), then sub-steps 350, 355 and 360 are executed in turn. In sub-step 350, the I^{th} element of array OMEAS is assigned the measure value for the currently identified supplier for the currently identified component of the currently identified design of the product. In sub-step 355, the I^{th} element of array OMANUF is assigned a value associated with the currently identified supplier, i.e., the supplier corresponding to the measure value assigned to the I^{th} element of OMEAS in sub-step 350. In sub-step 360, the I^{th} element of array ODESIGN is assigned a value associated with the currently identified design, i.e., the design corresponding to the measure value assigned to the I^{th} element of OMEAS in sub-step 350.

If in sub-step 340, the measure value is not “more optimal” than the I^{th} element of array OMEAS, then control continues with sub-step 380 without execution of sub-steps 350, 355 and 360.

At sub-step 380, control is returned to the execution loop of step 330, and the identification tag variable ranging over suppliers is incremented. At sub-step 390, control is returned to the execution loop of step 325, and the identification tag variable ranging over designs is incremented. At sub-step 400, control is returned to the execution loop of step 310, and the identification tag variable ranging over components is incremented. With each increment of an identification tag variable, sub-steps 340 and, if appropriate, sub-steps 350, 355 and 360 are performed, as described above.

The sub-steps shown in FIG. 3 and/or FIG. 4 may be varied in a way that achieves the same or substantially similar results as will be readily apparent to one skilled in the art in view of this specification; e.g., the execution loops shown may be nested differently, or the initialization discussed may be performed differently. All of such variations are within the scope and spirit of embodiments of the present invention.

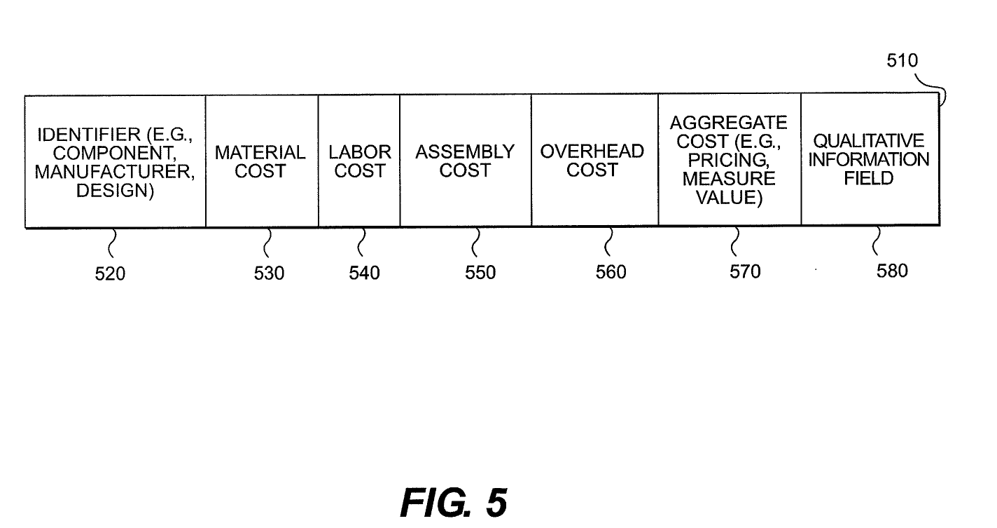

FIG. 5 shows an example data structure that contains measure values associated with a specific component supplied by a specific supplier of the selected product under a specific design. The data structure of FIG. 5 is an example shown for a context in which measure values represent prices and optimality has been defined in terms of a minimization of prices. One skilled in the art will recognize that data structures similar to the example of FIG. 5 may be used in other contexts and for other measure values.

Data structures as shown in FIG. 5 may be, for example, transmitted by suppliers to Sourcing Cost Determination System 10 of FIG. 1 (e.g., at step 230 of the embodiment depicted in FIG. 2), in response to communications by Sourcing Cost Determination System 10 requesting such information (e.g., after step 220 of the embodiment depicted in FIG. 2). In the data structure shown in FIG. 5, a vector measure value that includes a plurality of scalar measure values has been associated with a specific component supplied by a specific supplier of the selected product under a specific design. In the context where measure values represent price and optimality of measure values is defined in terms of minimization of price, transmission of a vector measure value instead of simply a total aggregate cost may be helpful, for example, in providing more detailed feedback to a supplier regarding where the supplier may be able to trim costs in response to benchmark information as determined in some embodiments of the present invention.

In the embodiment depicted in FIG. 5, Data Structure 510 contains one or more fields, such as Identifier Field 520, Material Cost Field 530, Labor Cost Field 540, Assembly Cost Field 550, Overhead Cost Field 560, Aggregate Cost Field 570 and Qualitative Information Field 580. Identifier Field 520 indicates the specific component, supplier and design to which Data Structure 510 pertains. Material Cost Field 530 contains the supplier's stated cost for the material of the component indicated in Field 520 under the design and supplier specified by Field 520. Labor Cost Field 540 contains the cost for labor of the component identified in Field 520 under the design and supplier specified by Field 520. Assembly Cost Field 550 contains the cost of assembly for the component indicated in Field 520 under the design and supplier specified by Field 520. Overhead Cost Field 560 contains the cost of overhead for the component indicated in Field 520 under the design and supplier specified by Field 520. Aggregate Cost Field 570 contains the aggregate cost for the component indicated in Field 520 under the design and supplier specified by Field 520. Finally, Qualitative Information Field 580 contains non-numeric data associated with the product, a component, a supplier or design that may be used to modify other numeric measure values or that may be used to derive a numeric measure value. Examples of such qualitative measure values include non-numeric indications of quality, credit ratings, etc., that may be translated into numeric measure values or that may be used to modify other quantitative measure values. For example, a qualitative measure value indicating a bad credit rating for a supplier may be used to adjust measure values received from that supplier in a way that reflects the added risk associated with the bad credit rating of the supplier (for example, where measure values reflect costs of components to the user, a bad credit rating associated with a supplier may be used to adjust the measure values reflecting costs from that supplier upwards to reflect the added risk).

In some embodiments, Sourcing Cost Determination System 10 may send data structures like Data Structure 510 to suppliers like Suppliers 50, 60 and 70 of FIG. 1 so that each supplier may populate the fields of Data Structure 510 with the information indicated above.

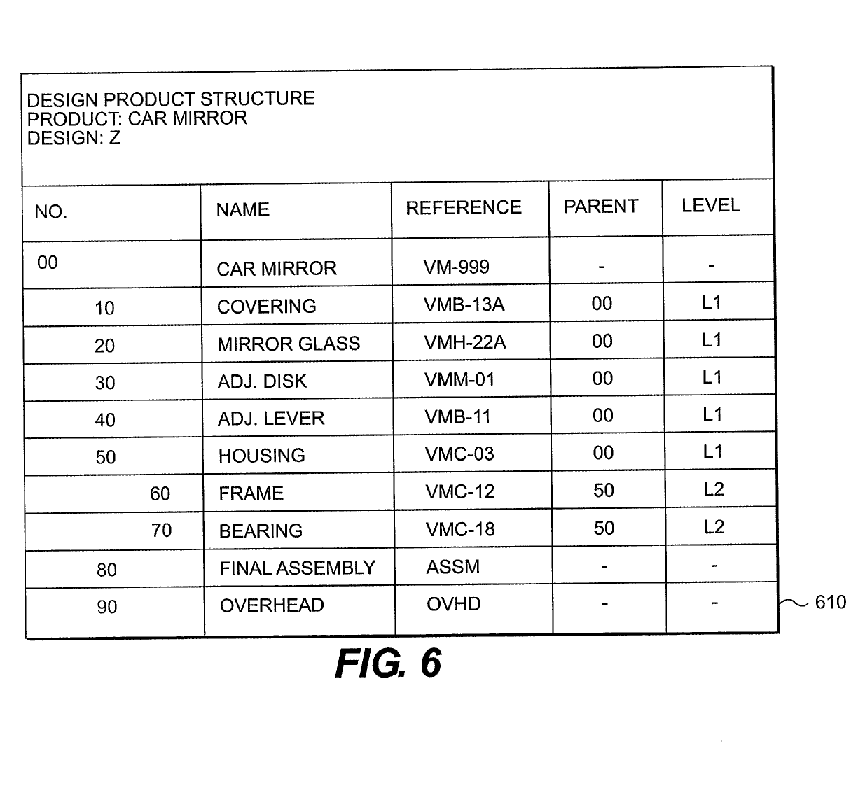

FIG. 6 shows product information, including component and sub-component information in an implementation of an embodiment of the present invention. For example, element 610 may be a graphical user interface (“GUI”) display of such information for the benefit of User 20 of FIG. 1. Such information may have been input into Sourcing Cost Determination System 10 by User 20, or may have been generated by Sourcing Cost Determination System 10 in response to a transmission by User 20. Products having multiple layers of components, e.g., products having at least one component that has subcomponents (or, as another example, at least one sub-component that has sub-sub-components and so on) may also be evaluated in embodiments of the invention, in a manner similar to the examples depicted in FIGS. 6-14.

By way of example, FIG. 6 indicates component and sub-component information for the Z design of a car mirror product. This product under the Z design has five components: a covering, a mirror glass, an adjustable disk, an adjusting lever and a housing. Further, GUI Display 610 indicates that the housing component includes two sub-components: a frame sub-component, and a bearing sub-component. As depicted in FIG. 6, GUI Display 610 also includes component reference information, and, for each component, information indicating whether the item is a component or subcomponent, and if it is a sub-component, the “parent” component of which it is a sub-component.

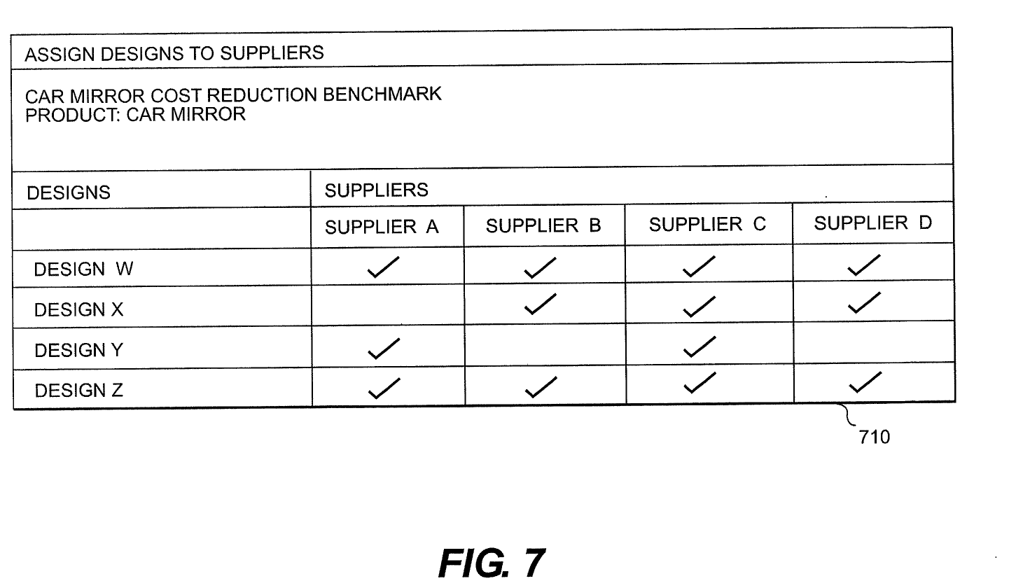

FIG. 7 shows information in table form indicating which suppliers are to be solicited for measure values for components of the selected product under a number of different designs. For example, Element 710 may be part of the GUI that utilizes user 20 in her interaction with Sourcing Cost Determination System 10. In the particular example shown in FIG. 7, a total of four suppliers are indicated for soliciting measure value information on four different designs of the car mirror product. The first data row in the table shown in GUI Display 710 indicates that measure value information will be solicited from all four suppliers—in this example, Supplier A, Supplier B, Supplier C and Supplier D for the W design. Similarly, the second data row indicates that measure value information is to be solicited from Supplier B, Supplier C and Supplier D for the X Design. The third data row in the table shown in GUI Display 710 indicates that only Supplier A and Supplier C are to be solicited for measure value information for the Y design. Finally, the fourth data row in the table shown in GUI Display 710 indicates that all four suppliers are to be solicited for measure value information for the product under the Z design.

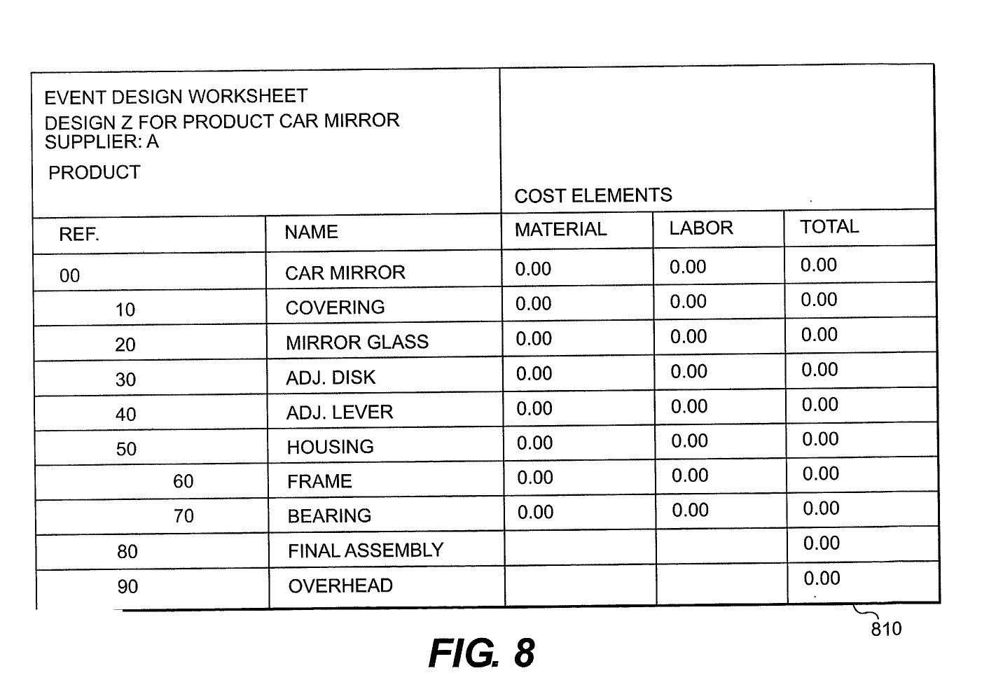

FIG. 8 shows an example of a design work sheet indicating the initial values for measure values—in this example, cost elements—for components and sub-components under a design of the selected product. This design work sheet may, for example, be part of User 20's GUI in her interactions with Sourcing Cost Determination System 10. In the example shown in GUI Display 810 a supplier—in this example, Supplier A—is to provide measure value information, including the costs of material, labor, overhead, and the aggregate cost, for each component or sub-component of the car mirror product under the Z design. In the example shown in GUI Display 810, and corresponding to the product information in GUI Display 610 of FIG. 6, the product under the Z design is indicated as having five physical components for which measure value information is to be obtained from suppliers: a covering, a mirror glass, an adjustable disk, an adjusting lever and a housing. Further, the housing component is indicated as having two sub-components, namely the frame sub-component and the bearing sub-component. FIG. 8 further shows that measure value information is to be obtained separately for the assembly cost of the components as well as overhead; in the example shown, these have been treated as categories that may be separately optimized or improved. In alternative implementations, the costs associated with such categories may be allocated among the physical components such that measure values for categories such as assembly and overhead are not separately solicited from suppliers.

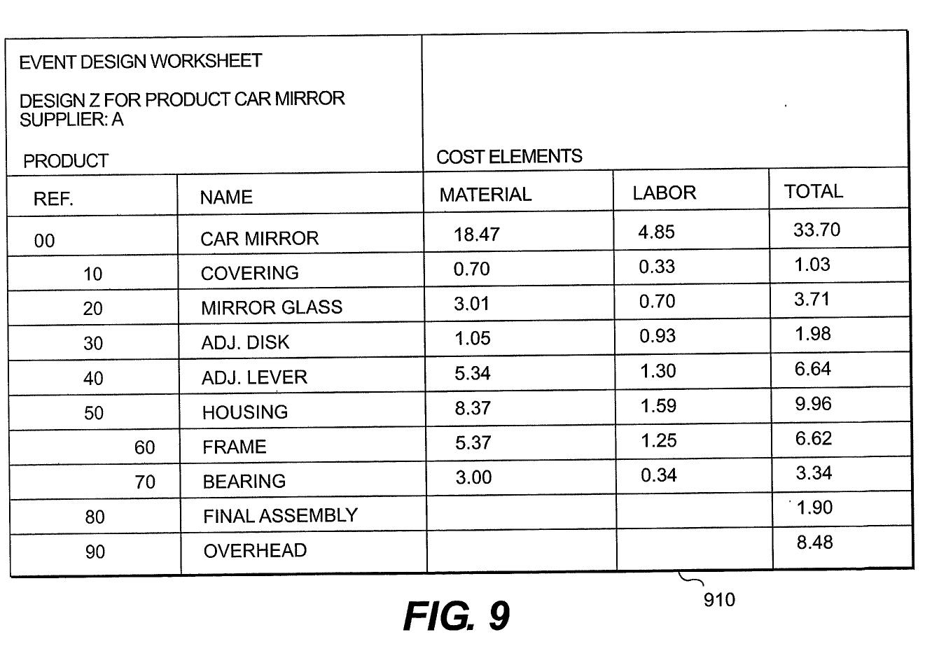

FIG. 9 shows an example of a design work sheet that is similar to the design work sheet in GUI Display 810 of FIG. 8, except that information from Supplier A has been received for the material cost, the labor cost and the aggregate cost for the components (including assembly cost and overhead cost which have been treated as separate components) and sub-components of the product under the Z design. In the example shown in GUI Display 910, the covering component, for example, is shown as having a material cost of 0.70 units and a labor cost of 0.33 units, according to the information received from Supplier A Similarly, costs have also been indicated in GUI Display 910 for each of the other components and sub-components of the product under the Z design. The costs received from Supplier A for final assembly and overhead, which in this example are being treated as components that may be separately optimized, are also indicated in GUI Display 910. GUI Display 910 may be displayed to the user as part of the graphical user interface of User 20 in her interactions with Sourcing Cost Determination System 10.

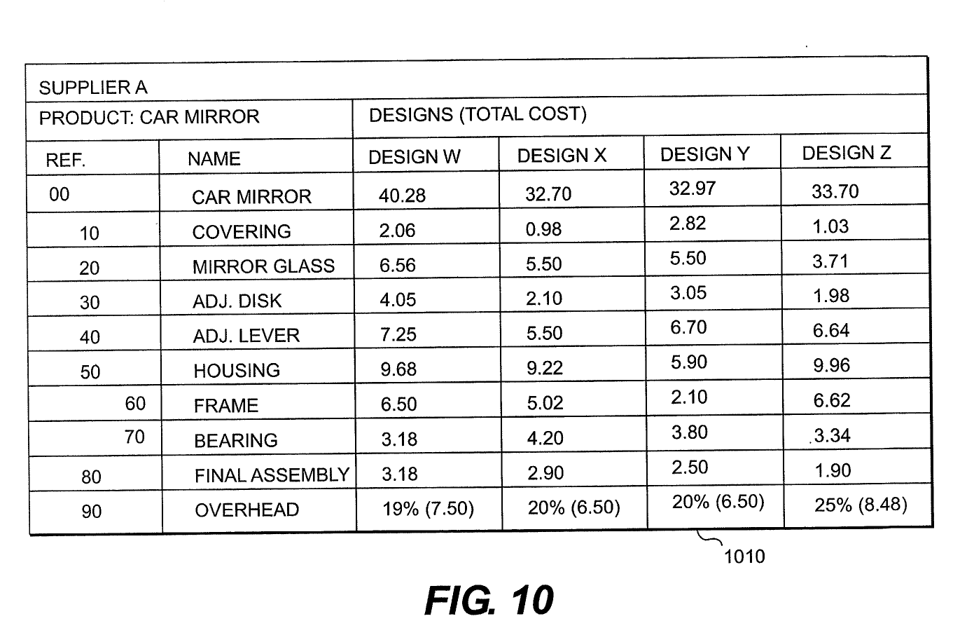

Continuing with this example, FIG. 10 shows a table indicating the aggregate cost under each of the designs for each component and sub-component of the car mirror product according to one of the suppliers (in this figure, Supplier A) Work sheet 1010 may, for example, be compiled and displayed to User 20 after measure value information as shown in FIG. 9 has been obtained for each of the designs under consideration from the indicated supplier. In the work sheet shown in Element 1010, the car mirror product is shown as having an aggregate cost of 40.28 units under the W design, an aggregate cost of 32.70 units under the X design, an aggregate cost of 32.97 units under the Y design and an aggregate cost of 33.70 units under the Z design, according to measure values received from Supplier A. Similarly, Work Sheet 1010 shows the aggregate cost for each component (including assembly cost and overhead cost, which in this example are being treated as components that may be separately optimized) and sub-component of the car mirror product under each of the four designs, as provided by Supplier A.

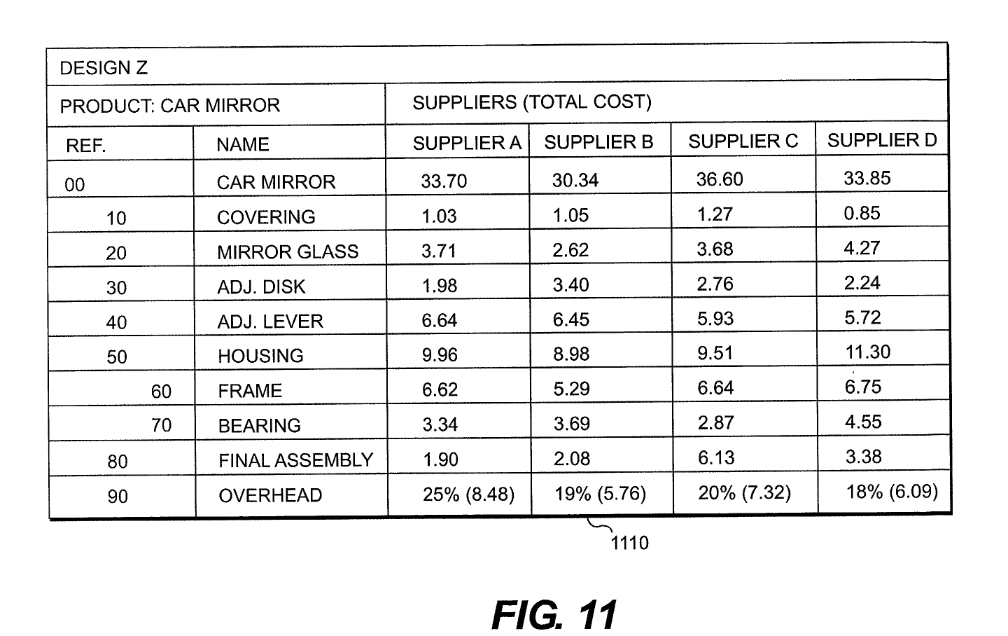

FIG. 11 shows a work sheet indicating the total aggregate cost for each of the components and sub-components of the car mirror product under the Z design for each of the potential suppliers (bidders) of that product under that design. Work Sheet 1110 may, for example, be constructed and displayed to User 20 after measure values as indicated in FIG. 9 are obtained for the specified design of the product from each of the potential suppliers. In the example shown in Work Sheet 1110, the aggregate cost for the car mirror product under the Z design is indicated as being 33.70 units for Supplier A; 30.34 units for Supplier B; 36.60 units for Supplier C; and 33.85 units for supplier Supplier D. Also similarly shown is the cost according to each of the identified suppliers for each of the components (including assembly cost and overhead cost, which in this example are being treated as components that may be separately optimized) and sub-components of the selected product under the indicated design.

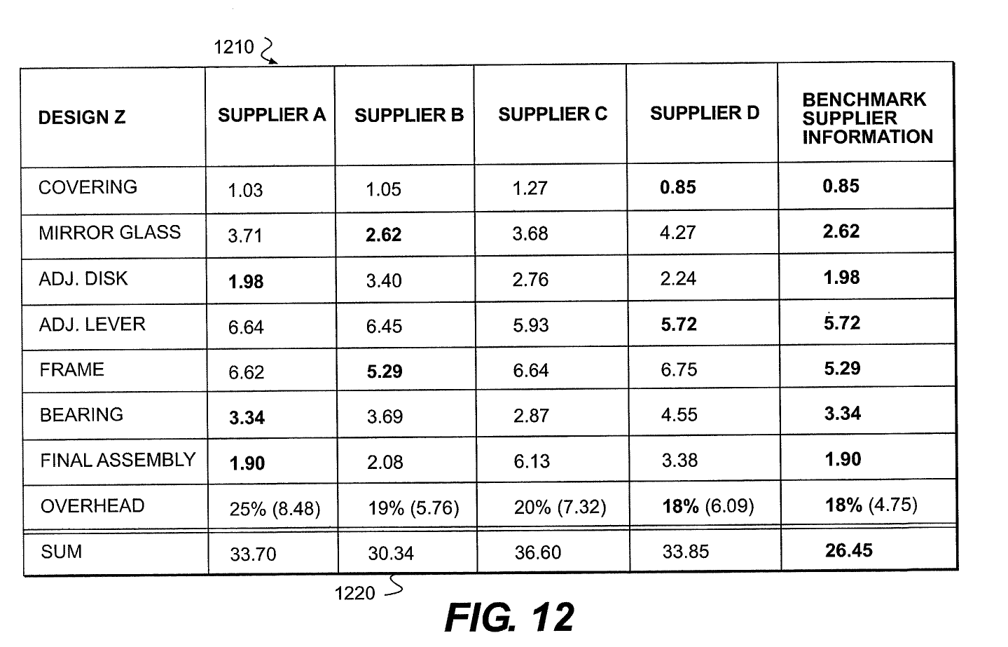

Continuing with the current example, FIG. 12 shows Work Sheet 1210 which provides benchmark supplier information for the selected product under the Z design. The benchmark supplier information includes, for each component, the optimum or best (in this example, the lowest cost) measure value from among the bids received for that component from the suppliers, and the supplier corresponding to that optimum measure value. Work Sheet 1210 may, for example, be part of the GUI through which User 20 exchanges information with Sourcing Cost Determination System 10.

Table 1220 of Work Sheet 1210 shows, among other things, the cost information received from each of the suppliers for each of the components of the selected product under the Z design. The last row of Table 1220 indicates the aggregate cost of the product under the Z design for each of the available suppliers of the product. For example, the aggregate cost for the exemplary car mirror product under the Z design is 33.70 units, according to Supplier A.

The final column in Table 1220 shows the optimal measure values for components of the product under the designation “Benchmark Supplier” for the car mirror product in the Z design. The benchmark supplier for the product under a particular design is understood to designate for each component of the product under the indicated design, the optimal measure value (cost, in this example) received for that component and the identity of the associated supplier. In the example shown in Work Sheet 1210, the measure value used is the cost for each component of the product as received from a plurality of suppliers. As indicated in the last column of Table 1220, the benchmark supplier for the indicated product under design Z includes information that the designated Benchmark Supplier cost for the covering component is 0.85 units, for the mirror glass component is 2.62 units, for the adjustable disc component is 1.98 units, for the adjustable lever component is 5.72 units, for the frame component is 5.29 units and for the bearing component is 3.34 units. In this example, the cost of assembly has been treated like an ordinary component that is to also be optimized in a way similar to that of other components; the designated Benchmark Supplier cost for assembly in this example is 1.90 units. Similarly, the overhead cost of the product has also been treated in this example like a component whose percentage value is to be optimized in a way similar to the optimization of the absolute cost of other components; in the example shown, the designated Benchmark Supplier cost for overhead is 18% of the aggregate of the other costs.

Additionally, Table 1220 also indicates that the benchmark supplier includes information that Supplier D is the optimal supplier for the covering component because of its lowest bid for that component of 0.85 units; that Supplier B is the optimal supplier for the mirror glass component because of its optimal bid for that component of 2.62 units, that Supplier A is the optimal supplier for the adjustable disc component because of that company's optimal bid of 1.98 units; that Supplier D is the optimal supplier for the adjusting lever because of Systems Corp.'s optimal bid of 5.72 units; that Supplier B is the optimal supplier for the frame component because of Supplier B's optimal bid of 5.29 units; that Supplier A is the optimal supplier for the bearing component because of Supplier A's optimal bid of 3.34 units for that component; that Supplier A is the optimal assembler because of Supplier A's optimal bid of 1.90 units for assembly; and that Supplier D provides the optimal “overhead cost” at 18% of the total aggregate of the other costs.

The entry in the final row and final column of Table 1220 indicates that designated Benchmark Supplier aggregate cost for the car mirror product under the Z design is 26.45 units. As can be seen from comparing this value to the aggregate cost listed for each individual supplier for the product under the Z design, the designated Benchmark Supplier aggregate cost is lower than (or more broadly, is more optimal than) the aggregate cost under the bids from each of the individual suppliers.

In some embodiments, feedback to the suppliers may be provided on the basis of the benchmark supplier information under each possible design, without further evaluating or determining benchmark design information.

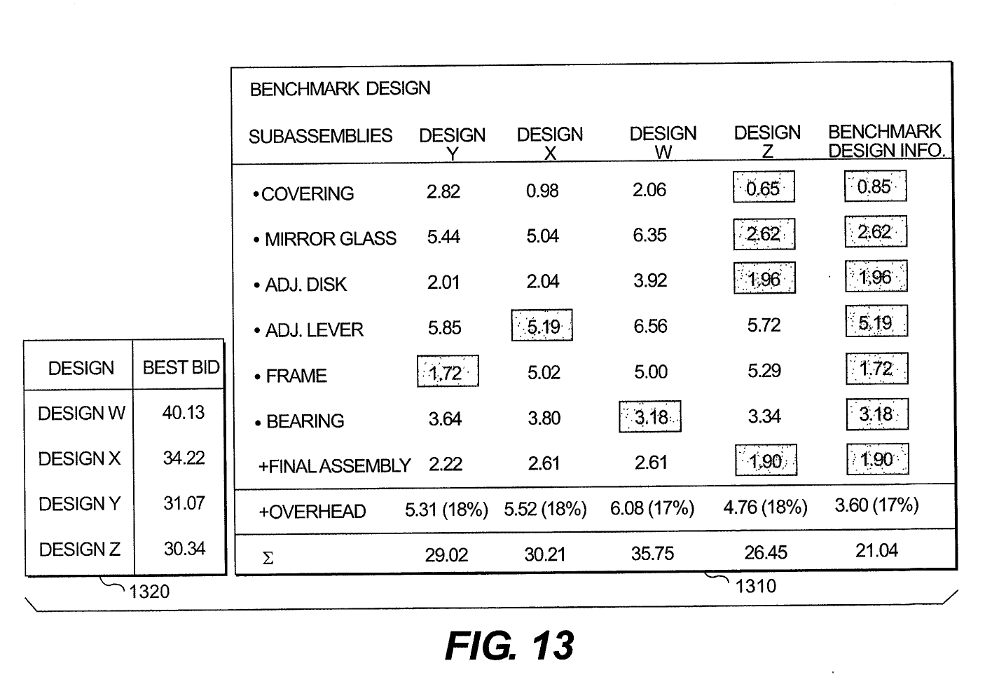

FIG. 13 illustrates a GUI display showing, among other things, i) benchmark design information for the exemplary car mirror product; ii) a comparison of the costs corresponding to the designated Benchmark Supplier under each of the different designs for the product; and (iii) the best aggregate bids for the product under each of the designs by each supplier. The GUI Display in FIG. 13 may, for example, be displayed to User 20 during her interaction with Sourcing Cost Determination System 10.

Table 1310 in its first four columns lists the optimal measure value (in this example, the lowest cost) for the indicated component from the benchmark supplier information corresponding to each of the four designs of the car mirror product. For example, the column labeled “Z” shows the measure values received for each of the components of the product associated with the designated Benchmark Supplier of the Z design. Similar designated Benchmark Supplier Information is also provided for each of the other designs. The final column labeled “Best Product”, in each row shows the optimal value (here, the lowest cost) from among the measure values from the benchmark supplier information for each design for the component indicated in that row. For example, the lowest cost for the covering component listed in Table 1310 is 0.85 units under the designated Benchmark Supplier in the Z design, whereas the lowest cost for the frame component is 1.72 units, which corresponds to the measure value of that component under the designated Benchmark Supplier for the Y design.

In the benchmark design information indicated in Table 1310, the covering component is shown as having the optimal measure value of 0.85 units, corresponding to the designated Benchmark Supplier for the Z design and, based on the benchmark supplier information from FIG. 12, was supplied by Supplier D; the mirror glass component is shown as having the optimal measure value 2.62 units, corresponding to the designated Benchmark Supplier for the Z design and, based on the benchmark supplier information from FIG. 12, was supplied by Supplier B; the adjustable disc component is shown as having the optimal measure value of 1.98 units, corresponding to the designated Benchmark Supplier for the Z design and, based on the benchmark supplier information from FIG. 12, was supplied by Supplier A; the adjusting lever component is indicated as having the optimal measure value of 5.19 units corresponding to the designated Benchmark Supplier for the X design; the frame component is shown as having the optimal measure value of 1.72, corresponding to the designated Benchmark Supplier for the Y design; the bearing component is shown as having the optimal measure value of 3.18, corresponding to the designated Benchmark Supplier for the W design; the final assembly cost, which is shown treated as a component in Table 1310, is indicated as having the optimal measure value of 1.90, corresponding to the designated Benchmark Supplier for the Z design; overhead, whose percentage value is shown treated like a component in Table 1310, is indicated as having the optimal measure value of 17%, corresponding to the designated Benchmark Supplier for the W Design. As shown in FIG. 13, the aggregate cost for the product in the designated Benchmark Design is 21.04 units.

Continuing with this example, Table 1320 of the GUI display shown in FIG. 13 indicates the best bid made by each supplier for each of the different designs. For example, for the design entitled “Z”, Table 1320 indicates that the best cost estimate received from any of the suppliers was 30.34 units. Table 1320 also shows the best cost estimates received from a single supplier for each of the other designs, namely the W, the X and the Y designs. As is readily observed from FIG. 13, the benchmark design information provides a lower aggregate cost for the exemplary car mirror product than any of the best bids received from the suppliers for the entire product.

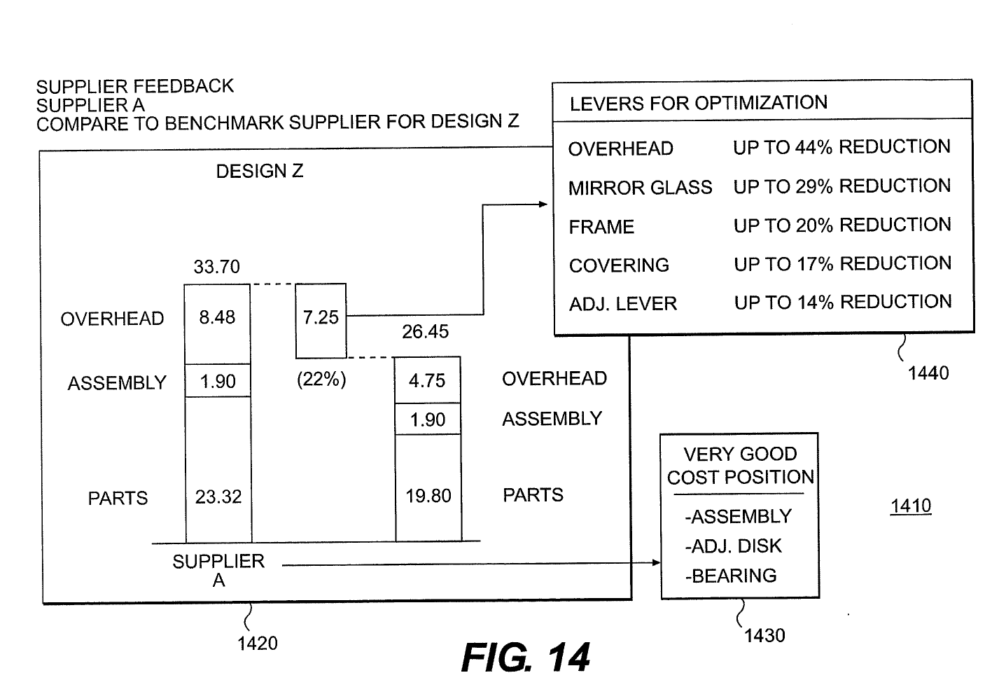

FIG. 14 depicts an example of a GUI display that may be used to provide feedback to one or more suppliers to obtain revised (i.e., subsequent) and “more optimal” (or otherwise improved) measure values from those suppliers after benchmark design information and/or benchmark supplier information have been determined. GUI Display 1410, for example, indicates the form in which feedback may be supplied to one or more suppliers on a graphical user interface. Element 1420 of GUI Display 1410 shows a comparison for a particular design of the aggregate measure value (here, aggregate costs) for a product as received from Supplier A and the aggregate cost as derived from the designated Benchmark Supplier Information for the indicated design. Other feedback may be provided, for example, comparing a supplier's measure value(s) to benchmark design information. Element 1420 also shows the cost breakdown for the aggregate cost received from the supplier and the aggregate cost under evaluated benchmark supplier information. Costs have been broken down in the example illustrated in Element 1420 in accordance with categories similar to those illustrated in FIG. 5.

In the example of Element 1420, in the cost information corresponding to the bid received from Supplier A, the parts cost element, representing the sum total of the cost of each of the parts of the product, is shown to be 23.32 units, whereas the assembly cost element for the product is shown as being 1.90 units, and, the overhead cost element is shown to be 8.48 units. The designated Benchmark Supplier Information for the indicated design, on the other hand, shows that the parts cost element is 19.80 units, whereas the assembly cost element is 1.90 units and the overhead cost element is 4.75 units.

Element 1420 may be used to provide feedback information to the supplier in connection with cost elements that may be possibly reduced by the supplier, given the lower aggregate cost under the evaluated benchmark supplier information or benchmark design information. Accordingly, Element 1440 of GUI Display 1410 identifies the components whose measure values may be reduced by the supplier, as well as percentage value indications of the reductions that may be possible. Similarly, Element 1430 of GUI Display 1410 identifies the components for which the measure values provided by the supplier are satisfactory. The information contained in FIG. 14, or analogous information, such as comparisons of the measure values provided by a supplier with benchmark design information, and/or the benchmark design information, may be sent or transmitted to the supplier to provide feedback to the supplier.

The user may utilize the benchmark information determined in embodiments of the invention in different ways depending on the context. For example, where the measure values represent prices of components and the goal is to minimize the total price of the product, benchmark information that is determined may be, e.g., transmitted to one or more suppliers in order to bargain with them to encourage them to provide revised bids that are lower than their original bids; or to source components from more than one supplier to minimize the total product cost (e.g., the supplier that is to provide assembly services may be determined by minimizing the assembly costs for the components—in such a case “assembly” may be treated as a separate component and assembly costs may be treated like a separate measure value). Similarly, benchmark information may be sold to parties who may economically benefit from such information. More generally, benchmark information may be used to make sourcing decisions in a manner that provides a benefit.

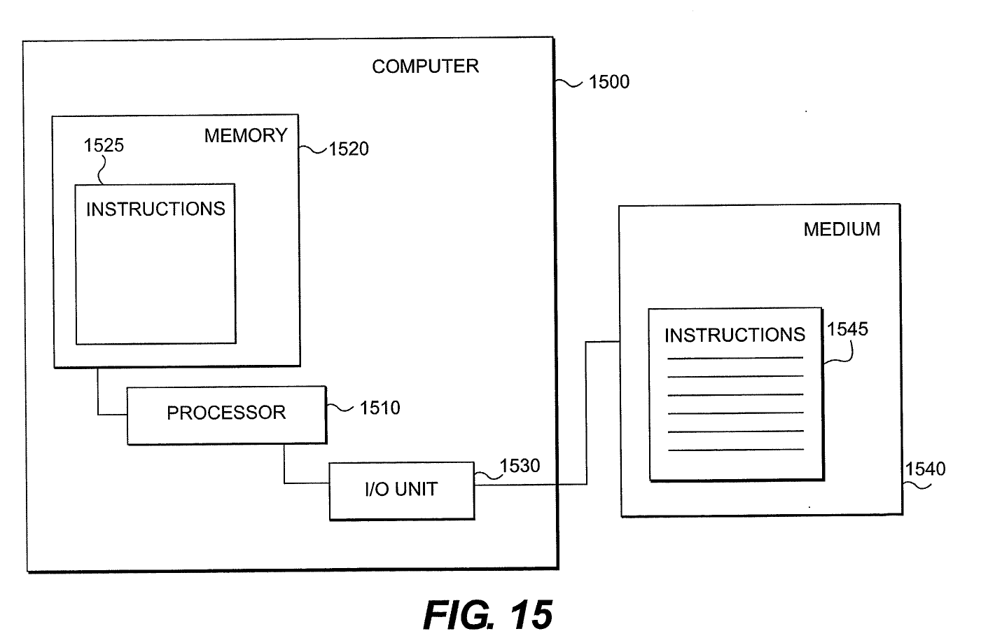

FIG. 15 shows an example of an apparatus used in some embodiments of the present invention. In FIG. 15, a medium 1540 containing Instructions 1545 may be connected to a Computer 1500. For example, Instructions 1545 may contain the steps in an embodiment of a method of the present invention. For example, Instructions 1545 may comprise the instructions shown in FIGS. 2, 3 and 4 in a specific implementation. In the example depicted in FIG. 15, Computer 1500 contains a Processor 1510 which is connected to an Input/Output Unit 1530 and a Memory 1520. Memory 1520 may also have Instructions 1525, which correspond to the steps in an embodiment of a method of the present invention. In a specific implementation, Instructions 1545 of Medium 1540 may be copied into Memory 1520.

Additionally, propagating signals embodied in a medium, such as a carrier wave or other carrier medium, that are products of embodiments of methods of the invention, or products of the use of embodiments of systems or devices of the present invention are within the scope and spirit of the present invention and the appended claims.

Many variations of the embodiments described in this specification are possible. All of these variations are within the scope and spirit of the invention and the appended claims. In one variation, measure values received in connection with a product or components of a product may be adjusted to reflect differences among certain components and/or designs on the one hand, and other components and/or designs of the product on the other hand. For example, where a particular design of the product reflects one or more functional features that are not present in one or more other designs under consideration, the measure values received from bidders for one or more of the components of the product may be adjusted (e.g., downwards, where measure values represent prices and minimization of prices is the object) to account for the added feature(s) in the particular design. An analogous adjustment upwards in the measure values representing cost under a design may be made where that design is missing one or more functional features present in other designs under consideration.

Adjustments to measure values may also be made in other contexts and for other reasons, as will be apparent to one of skill in the art in view of this specification. For example, where a component of a design of a product is not readily interchangeable with components of other designs, adjustments to the measure values of the non-interchangeable component may be made in the comparison process to reflect the non-interchangeability of that component. One skilled in the art will, in view of the present specification, be able to make appropriate adjustments to measure values in a manner that will reflect her purposes or needs.

In a context where measure values represent prices of components, cost categories associated with a subset or all of the components, such as assembly costs and overhead costs, may also be considered in the comparison process by treating such cost categories as independent components. For example, the assembly cost for components and the percentage value of overhead may be treated as components, as illustrated in the example considered in FIGS. 12-14. Other alternatives will be apparent to one skilled in the art in view of this specification. For example, the assembly costs and/or overhead costs, instead of being treated as separate cost categories in a manner similar to physical components, may be allocated to the costs of the physical components (e.g., in a manner proportionate to the ratio of the cost of a physical component to the total cost of all components). All of these variations are within the scope and spirit of embodiments of the invention and the appended claims.

The structures shown and discussed in apparatus embodiments of the invention are exemplary only and the functions performed by these structures may be performed by any number of structures. For example, the functions performed by the units shown within Sourcing Cost Determination System 10 may be performed by a single physical unit, or may be allocated across any number of different physical units. All of such possible variations are within the scope and spirit of embodiments of the invention and the appended claims.

The present invention has been described in terms of several embodiments solely for the purpose of illustration. Persons skilled in the art will recognize from this description that the invention is not limited to the embodiments described, and may be practiced with modifications and alterations limited only by the spirit and scope of the appended claims which are intended to cover such modifications and alterations, so as to afford broad protection to the invention and its equivalents.

What is claimed is:

1. A method for making a sourcing decision comprising:
a) designating a product, the product having a plurality of designs and a set of components;
b) for each component,
for each design incorporating that component,
receiving a measure value corresponding to that component incorporated in that design, from each of a plurality of suppliers of that component for that design; and
c) responsive to b), for each component, determining a preferred design and a preferred supplier.

2. The method of claim 1 further comprising:
d) transmitting information on the preferred design and the preferred supplier, for each component, and
e) receiving at least one subsequent measure value from at least one supplier from the plurality of suppliers.

3. The method of claim 2 further comprising:
f) responsive to e), determining a subsequent preferred design and a subsequent preferred supplier.

4. A method for making a sourcing decision comprising:
a) designating a product, the product having a plurality of designs and a set of components;
b) for each component,
each design incorporating that component,
receiving a measure value corresponding to that component incorporated in that design, from each of a plurality of suppliers of that component for that design;
c) responsive to b), determining a preferred design and a preferred supplier for each component from the set of components;
d) transmitting information on the preferred design and the preferred supplier, for each of the components;
e) receiving at least one subsequent measure value from at least one supplier from the plurality of suppliers; and
f) responsive to e), determining a subsequent preferred design and a subsequent preferred supplier.

5. A method for making a sourcing decision comprising:
a) designating a product, the product having a plurality of designs and a set of components;
b) for each component,
for each design incorporating that component,
receiving a measure value corresponding to that component incorporated in that design, from each of a plurality of suppliers of that component for that design;
c) adjusting at least one of the received measure values; and
d) responsive to b) and c), determining a preferred design and a preferred supplier for each component.

6. The method of claim 5 further comprising:
e) transmitting information on the preferred design and the preferred supplier, for each component and
f) receiving at least one subsequent measure value from at least one supplier from the plurality of suppliers.

7. The method of claim 6 further comprising:
g) responsive to f), determining a subsequent preferred design and a subsequent preferred supplier.

8. The method of claim 5 in which c) is responsive to a functional difference between i) a first design, of the plurality of designs, including a first-design component corresponding to the at least one received measure value, and (ii) a second design of the plurality of designs.

9. The method of claim 5 in which c) is responsive to the non-interchangeability of (i) a first-design component, corresponding to the at least one received measure value in a first design of the plurality of designs; and (ii) a second-design component in a second design of the plurality of designs.

10. A method for making a sourcing decision comprising:
a) designating a product, the product having a plurality of designs and a set of components;
b) for each component,
for each design incorporating that component,
receiving a measure value corresponding to that component incorporated in that design, from each of a plurality of suppliers of that component for that design;
c) adjusting at least one of the received measure values;
d) responsive to b) and c), determining a preferred design and a preferred supplier for each component;
e) transmitting information on the preferred design and the preferred supplier, for each component;
f) receiving at least one subsequent measure value from at least one supplier from the plurality of suppliers; and
g) responsive to f), determining a subsequent preferred design and a subsequent preferred supplier.

11. A method for making a sourcing decision comprising:
a) designating a product having a set of components;
b) for each component,
receiving a measure value corresponding to that component, from each of a plurality of suppliers of that component;
c) responsive to b), determining a preferred supplier for each component;
d) transmitting information on the preferred supplier for each component; and
e) receiving at least one subsequent measure value from at least one supplier from the plurality of suppliers.

12. A method for making a sourcing decision comprising:
a) designating a product, the product having a set of components and having a plurality of designs;
b) for each design, obtaining pricing data for each component included in that design, from each of a plurality of suppliers; and
c) determining benchmark supplier information for each design.

13. The method of claim 12 in which c) comprises determining, for each design, a preferred supplier for each component.

14. The method of claim 12 further comprising:
d) transmitting the benchmark supplier information for at least one design from the plurality of designs;
e) receiving subsequent pricing data from at least one supplier from the plurality of suppliers; and
f) responsive to e), determining a subsequent benchmark supplier information for the at least one design.

15. A method for making a sourcing decision comprising:
a) designating a product, the product having a set of components and having a plurality of designs;
b) for each design, obtaining pricing data for each component included in that design, from each of a plurality of suppliers;
c) determining benchmark supplier information for each design;
d) transmitting the benchmark supplier information for at least one design;
e) receiving new pricing data from at least one supplier from the plurality of suppliers; and
f) responsive to e), determining a subsequent benchmark supplier information for the at least one design.

16. A method for making a sourcing decision comprising:
a) designating a product, the product having a set of components and having a plurality of designs;
b) for each design, obtaining pricing data for each component included in that design, from each of a plurality of suppliers; and
c) determining benchmark design information.

17. The method of claim 16 wherein c) comprises determining a preferred supplier for each component considering each design from the plurality of designs.

18. The method of claim 16 further comprising:
d) transmitting the benchmark design information;
e) following the transmitting step, receiving new pricing data from at least one supplier from the plurality of suppliers; and
f) responsive to e), determining a subsequent benchmark design information.

19. A method for making a sourcing decision comprising:
a) designating a product, the product having a set of components and having a plurality of designs;
b) for each design, obtaining pricing data for each component included in that design, from each of a plurality of suppliers;
c) determining benchmark design information;
d) transmitting the benchmark design information;
e) receiving new pricing data from at least one supplier from the plurality of suppliers; and
f) responsive to e), determining a subsequent benchmark design information.

20. A computer-readable medium having stored thereon instructions, which when executed by a processor, cause the processor to perform a method comprising:
a) designating a product, the product having a set of components and having a plurality of designs;
b) for each design, obtaining pricing data for each component included in that design, from each of a plurality of suppliers; and
c) determining benchmark supplier information for each design.

21. The computer-readable medium of claim 20 further comprising instructions, which, when executed by the processor cause the processor to further perform:
d) transmitting the benchmark supplier information for at least one design from the plurality of designs.
e) receiving subsequent pricing data from at least one supplier from the plurality of suppliers following the transmitting step; and
f) responsive to e), determining a subsequent benchmark supplier information for the at least one design.

22. A computer-readable medium having stored thereon instructions, which when executed by a processor, cause the processor to perform a method comprising::
a) designating a product, the product having a set of components and having a plurality of designs;
b) for each design, obtaining pricing data for each component included in that design, from each of a plurality of suppliers;
c) determining benchmark supplier information for each design;
d) transmitting the benchmark supplier information for at least one design from the plurality of designs;
e) receiving subsequent pricing data from at least one supplier from the plurality of suppliers; and
f) responsive to e), determining a subsequent benchmark supplier information for the at least one design.

23. A computer-readable medium having stored thereon instructions, which when executed by a processor, cause the processor to perform a method comprising:
a) designating a product, the product having a set of components and having a plurality of designs;
b) for each design, obtaining pricing data for each component included in that design, from each of a plurality of suppliers; and
c) determining benchmark design information.

24. The computer-readable medium of claim 23 further comprising instructions, which, when executed by the processor cause the processor to further perform:
d) transmitting the benchmark design information;
e) receiving subsequent pricing data from at least one supplier from the plurality of suppliers; and
f) responsive to e), determining a subsequent benchmark design information.

25. A computer-readable medium having stored thereon instructions, which when executed by a processor, cause the processor to perform a method comprising::
a) designating a product, the product having a set of components and having a plurality of designs;
b) for each design, obtaining pricing data for each component included in that design, from each of a plurality of suppliers;
c) determining benchmark design information;
d) transmitting the benchmark design information;
e) receiving subsequent pricing data from at least one supplier from the plurality of suppliers; and
f) responsive to e), determining a subsequent benchmark design information.

26. A computer-readable medium having stored thereon instructions, which when executed by a processor, cause the processor to perform a method comprising:
a) designating a product, the product having a plurality of designs and a set of components;
b) for each component,
for each design incorporating that component,
receiving a measure value corresponding to that component incorporated in that design, from each of a plurality of suppliers of that component for that design;
c) responsive to b), determining a preferred design and a preferred supplier for each component;
d) transmitting information on the preferred design and the preferred supplier, for each component;
e) receiving at least one subsequent measure value from at least one supplier from the plurality of suppliers; and
f) responsive to e), determining a subsequent preferred design and a subsequent preferred supplier.

27. A computer-readable medium having stored thereon instructions, which when executed by a processor, cause the processor to perform a method comprising:
a) designating a product, the product having a plurality of designs and a set of components;
b) for each component,
for each design incorporating that component,
receiving a measure value corresponding to that component incorporated in that design, from each of a plurality of suppliers of that component for the design;
c) adjusting at least one of the received measure values;
d) responsive to b) and c), determining a preferred design and a preferred supplier for each component;
e) transmitting information on the preferred design and the preferred supplier for each component;
f) receiving at least one subsequent measure value from at least one supplier from the plurality of suppliers; and
g) responsive to f), determining a subsequent preferred design and a subsequent preferred supplier.

28. A computer-readable medium having stored thereon instructions, which when executed by a processor, cause the processor to perform a method comprising::
a) designating a product having a set of components;
b) for each component,
receiving a measure value corresponding to that component, from each of a plurality of suppliers of that component;
c) responsive to b), determining a preferred supplier for each component;
d) transmitting information on the preferred supplier for each component; and
e) receiving at least one subsequent measure value from at least one supplier from the plurality of suppliers.

29. An apparatus for making a sourcing decision, the apparatus comprising:
a product designation unit connected to a processing unit and configured to designate a product, a plurality of designs for the product and a set of components for the product;
an input unit connected to the processing unit and configured to receive:
for each component,
for each design incorporating that component,
a measure value corresponding to that component incorporated in that design, from each of a plurality of suppliers of that component for that design;
wherein the processing unit is configured to determine a preferred design and a preferred supplier for each component based on the measure values received by the input unit; and
an output unit connected to the processor and configured to transmit information on the preferred design and the preferred supplier for each component.

30. The apparatus of claim 29 in which:
the input unit is additionally configured to receive and transmit to the processing unit at least one new measure value from at least one supplier from the plurality of suppliers; and
the processing unit is additionally configured to determine a subsequent preferred design and a subsequent preferred supplier in response to a transmission from the input unit of the at least one measure value.

31. The apparatus of claim 29 in which the processing unit is additionally configured to perform an adjustment to at least one measure value received by the input unit.

32. An apparatus for making a sourcing decision, the apparatus comprising:
a product designation unit connected to a processing unit and configured to designate a product and a set of components for the product;
an input unit connected to the processing unit and configured to receive:
for each component,
a measure value corresponding to that component, from each of a plurality of suppliers of that component,
wherein the processing unit is configured to determine a preferred supplier for each component based on the measure values received by the input unit; and
an output unit connected to the processor and configured to transmit information on the preferred supplier for each component.

33. The apparatus of claim 32 in which:
the input unit is additionally configured to receive and transmit to the processing unit at least one new measure value from at least one supplier from the plurality of suppliers; and
the processing unit is additionally configured to determine a subsequent preferred supplier in response to a transmission from the input unit of the at least one new measure value.

34. An apparatus for making a sourcing decision, the apparatus comprising:
a product designation unit connected to a processing unit and configured to designate a product, a plurality of designs for the product, and a set of components for the product;
an input unit connected to the processing unit and configured to obtain pricing data for each component from each of a plurality of suppliers, for each design,
wherein the processing unit is configured to determine benchmark supplier information for each design; and
an output unit connected to the processing unit and configured to transmit the benchmark supplier information for at least one design.

35. The apparatus of claim 34, in which:
the input unit is additionally configured to receive and transmit to the processing unit subsequent pricing data from at least one supplier from the plurality of suppliers; and
the processing unit is additionally configured to determine a subsequent benchmark supplier information in response to a transmission from the input unit of the subsequent pricing data.

36. An apparatus for making a sourcing decision, the apparatus comprising:
a product designation unit connected to a processing unit and configured to designate a product, a plurality of designs for the product, and a set of components for the product;
an input unit connected to the processing unit and configured to obtain pricing data for each component from each of a plurality of suppliers, for each design,
wherein the processing unit is configured to determine benchmark design information; and
an output unit connected to the processing unit and configured to transmit the benchmark design information,

37. The apparatus of claim 36, in which:
the input unit is additionally configured to receive and transmit to the processor unit subsequent pricing data from at least one supplier from the plurality of suppliers; and
the processing unit is additionally configured to determine a subsequent benchmark design information in response to a transmission from the input unit of the subsequent pricing data.

38. A signal embedded in a medium representing data representing benchmark supplier information for at least one design of a product having a set of components, a plurality of designs, and a plurality of manufacturers for the set of components.

39. The signal of claim 38 in which the benchmark supplier information for the at least one design represents a determination of, for each component incorporated in the at least one design, a preferred supplier from the plurality of suppliers.

40. A signal embedded in a medium representing data including benchmark supplier information for at least one design of a product having a set of components, a plurality of designs, and a plurality of manufacturers, wherein the benchmark supplier information for the at least one design represents a determination of, for each component incorporated in the at least one design, a preferred supplier from the plurality of suppliers.

41. A signal embedded in a medium representing data including benchmark supplier information in which the benchmark supplier information has been determined as a result of execution by a processor of encoded instructions comprising:
a) designating a product having a set of components;
b) for each component,
receiving a measure value corresponding to that component, from each of a plurality of suppliers of that component; and
c) responsive to b), determining the benchmark supplier information for each component.

42. A signal embedded in a medium representing data including a subsequent benchmark supplier information in which the subsequent benchmark supplier information has been determined as a result of execution by a processor of encoded instructions comprising:
a) designating a product having a set of components;
b) for each component,
receiving a measure value corresponding to that component, from each of a plurality of suppliers of that component;
c) responsive to b), determining the benchmark supplier information;
d) transmitting the benchmark supplier information;
e) receiving at least one subsequent measure value from at least one supplier from the plurality of suppliers; and
f) responsive to e), determining the subsequent benchmark supplier information.

43. A signal embedded in a medium representing data including benchmark design information for a product having a set of components, a plurality of designs, and a plurality of manufacturers for the set of components.

44. The signal of claim 41 in which the benchmark design information represents a determination of, for each component, a preferred supplier from the plurality of suppliers, considering all designs from the plurality of designs incorporating that component.

45. A signal embedded in a carrier wave representing data including benchmark design information for a product having a set of components, a plurality of designs, and a plurality of manufacturers for the set of components, in which the benchmark design information represents a determination of, for each component, a preferred supplier from the plurality of suppliers, considering all designs from the plurality of designs incorporating that component.

46. A signal embedded in a medium representing data including benchmark design information in which the benchmark design information has been determined as a result of execution by a processor of encoded instructions comprising:
a) designating a product, the product having a plurality of designs and a set of components;
b) for each component,
for each design incorporating that component,
receiving a measure value corresponding to that component incorporated in that design, from each of a plurality of suppliers of that component for that design; and
c) responsive to b), determining the benchmark design information.

47. A signal embedded in a medium representing data including benchmark design information in which the benchmark design information has been determined as a result of execution by a processor of encoded instructions comprising:
a) designating a product, the product having a plurality of designs and a set of components;
b) for each component,
for each design incorporating that component,
receiving a measure value corresponding to that component incorporated in that design, from each of a plurality of suppliers of that component for that design;
c) adjusting at least one of the received measure values; and
d) responsive to b) and c), determining the benchmark design information.

48. A signal embedded in a medium representing data including a subsequent benchmark design information in which the subsequent benchmark design information has been determined as a result of execution by a processor of encoded instructions comprising:
a) designating a product, the product having a plurality of designs and a set of components;
b) for each component,
for each design incorporating that component,
receiving a measure value corresponding to that component incorporated in that design, from each of a plurality of suppliers of that component for that design;
c) adjusting at least one of the received measure values;
d) responsive to b) and c), determining benchmark design information;
e) transmitting the benchmark design information;
f) receiving at least one subsequent measure value from at least one supplier from the plurality of suppliers; and
g) responsive to f), determining the subsequent benchmark design information.

49. An apparatus for making a sourcing decision comprising:
a) means for designating a product, the product having a plurality of designs and a set of components;
b) means for receiving, for each component,
for each design incorporating that component,
a measure value corresponding to that component incorporated in that design, from each of a plurality of suppliers of that component for that design; and
c) means for determining, responsive to b), a preferred design and a preferred supplier.

50. An apparatus for making a sourcing decision comprising:
a) means for designating a product, the product having a plurality of designs and a set of components;
b) means for receiving, for each component,
for each design incorporating that component,
a measure value corresponding to that component incorporated in that design, from each of a plurality of suppliers of that component for that design; and
c) means for determining, responsive to b), a preferred design and a preferred supplier;
d) means for transmitting information on the preferred design and the preferred supplier, for each of the components;
e) means for receiving at least one subsequent measure value from at least one supplier from the plurality of suppliers; and
f) means for determining a subsequent preferred design and a subsequent preferred supplier, based on the at least one subsequent measure value received by the means of e).

51. An apparatus for making a sourcing decision comprising:
a) means for designating a product, the product having a plurality of designs and a set of components;
b) means for receiving, for each component,
for each design incorporating that component,
a measure value corresponding to that component incorporated in that design, from each of a plurality of suppliers of that component for that design;
c) means for adjusting at least one of the received measure values; and
d) means for, responsive to b) and c), determining a preferred design and a preferred supplier for each component.

52. An apparatus for making a sourcing decision comprising:
a) means for designating a product, the product having a plurality of designs and a set of components;
b) means for receiving, for each component,
for each design incorporating that component,
a measure value corresponding to that component incorporated in that design, from each of a plurality of suppliers of that component for that design;
c) means for adjusting at least one of the received measure values;
d) means for, responsive to b) and c), determining a preferred design and a preferred supplier for each component;
e) means for transmitting information on the preferred design and the preferred supplier, for each component;
f) means for receiving at least one subsequent measure value from at least one supplier from the plurality of suppliers; and
g) means for determining a subsequent preferred design and a subsequent preferred supplier, based on the at least one subsequent measure value received by the means of f).

53. An apparatus for making a sourcing decision comprising:
a) means for designating a product having a set of components;
b) means for receiving, for each component,
a measure value corresponding to that component, from each of a plurality of suppliers of that component;
c) means for, responsive to b), determining a preferred supplier for each component;
d) means for transmitting information on the preferred supplier for each component; and
e) means for receiving at least one subsequent measure value from at least one supplier from the plurality of suppliers.
